(19) United States
(12) Patent Application Publication
(10) Pub. No.: US 2025/0291611 A1
(43) Pub. Date: Sep. 18, 2025

(54) PATHWAY STRUCTURED USER INTERFACE FOR CYBERSECURITY APPLICATIONS

(71) Applicant: LogRhythm, Inc., Broomfield, CO (US)

(72) Inventors: Matt WILLEMS, Broomfield, CO (US); Nick Trombley, Broomfield, CO (US)

(21) Appl. No.: 19/010,982

(22) Filed: Jan. 6, 2025

Related U.S. Application Data
(60) Provisional application No. 63/617,610, filed on Jan. 4, 2024.

(51) Int. Cl. G06F 9/451; G06F 3/0482; G06F 3/04847; H04L 9/40

(52) U.S. Cl. CPC G06F 9/451; G06F 3/0482; G06F 3/04847; H04L 63/20

(57) ABSTRACT

A cybersecurity system generates user interface (100) including a root panel (102) and a series of adjacent panels (103-105). The root panel (102) represents the starting point of a workflow, for example, the results of a search query entered by an analyst. The root panel (102) provides a selection of interactive elements that can be used by an analyst to launch an investigation. The interactive elements may include hyperlinks to access additional information about an alert or other event or to drill down into particular fields of data. Selection of one of these interactive elements causes the system to generate a panel (103) adjacent to the root panel (102). Additional panels (104 and 105), in the illustrated workflow, are generated in response to selecting interactive elements from the preceding panel. A single user interface thus includes panels structured to reflect and memorialize a workflow of an investigation.

### RELATED APPLICATION INFORMATION

The present application is a non-provisional of U.S. Provisional Pat. Appl. Ser. No. 63/617,610 entitled, “Pathway Structured User Interface for Cybersecurity Applications” filed on Jan. 4, 2024 (“the Parent Application”). The content of the Parent Application is incorporated herein by reference as if set forth in full and priority is claimed to the full extent allowable under U.S. law and regulations.

### FIELD OF THE INVENTION

The present invention relates generally to cybersecurity applications and, in particular, to a system and associated functionality for managing a workflow in a cybersecurity application to facilitate exploration of multiple investigative pathways and enable efficient and timely resolution of events.

### BACKGROUND

Cybersecurity applications, such as Security Information and Event Management (SIEM) applications, are generally used for monitoring computer networks to identify and analyze potential threats. The application may monitor network traffic to identify activities or patterns of activity that are anomalous or otherwise warranting analysis. Depending on the application, such activities may be further analyzed to distinguish benign activities from potential threats. In addition, these applications may monitor other network conditions of interest that are not potential threats such as available storage or other constraints. In any event, certain conditions, activities, or patterns of activity may be identified as events for analysis by a cybersecurity analyst. The analyst can use a variety of tools to analyze and resolve an event. Such resolution may involve, for example, identifying the event as benign, escalating the event for further analysis, or implementing protective or corrective measures in response to the event.

The investigation by the analyst may involve drilling down into the details of a suspicious item, pivoting to a different branch of inquiry, suspending or abandoning a particular path of inquiry because it is not proving fruitful, backtracking to a decision point to pursue a different branch of inquiry, or resuming a previously abandoned branch of inquiry based on new evidence or insight. However, in many cases, it is difficult for an analyst to follow a train of thought that may involve a series of decisions defining a complex investigative workflow while simultaneously documenting the workflow to facilitate retracing steps, pivoting, or marking pathways that have not proved fruitful. The result can be inefficient replication of work, confusion, and loss of discipline in identifying and timely resolving potentially urgent events.

This can be illustrated by considering a representative workflow of a cybersecurity analyst tasked with analyzing threats to a computer network. Such an analyst may initiate an analysis by accessing a cybersecurity application and initiating a search to identify potential events of interest. For example, the analyst may use filters to identify all high-impact alerts occurring within the last 24 hours. This may yield a list of log messages, for example, including fields identifying the event type, log type, log source, a user associated with the log, a host ID, and similar information.

The analyst may then identify one of the logs for further investigation. For example, the analyst may be interested in a log associated with an “unauthorized origin” event type. In conventional systems, the analyst may select the log from the list or data grid and click on the log to obtain more information about the log. In response, the analyst may be presented with a Log Message Analytics screen that presents detailed information about why the alert was generated, e.g., a summary of the activities or data fields and values that rendered the log suspicious. For example, the summary may indicate that the log was related to a Brute Force Access Attempt where multiple authentication failures against a target IP address were followed by an authentication success.

Upon reviewing the log message analytics, the analyst may note that there is an open case related to the log message or a related message. The analyst may therefore open a link to that case file to see what the prior investigation revealed. The case file may include notes from the prior analyst as well as, for example, multiple log messages attached to the file as evidence.

One or more of these log messages attached as evidence in the prior investigation may be interesting to the current analyst in relation to the recent alert. Accordingly, in a series of actions, the analyst may successively open files associated with each of these logs, drill down into further details concerning one or more of these logs, and iteratively return to the page where the log files attached as evidence, in the prior investigation, were listed.

This series of actions by the analyst may be thought of as an investigative workflow with many decisions defining a complex network of decision nodes and associated pathways. It is the nature of such investigations that various outcomes are possible for each such investigative pathway. The pathway may reveal that the log message, though initially identified as suspicious based on application of sound logic is, in fact, not a threat or otherwise benign. The event may therefore be deemed resolved. Conversely, the pathway may yield further evidence that the log message is associated with a potential threat requiring action. The event may therefore be escalated for further analysis or remedial action, e.g., preventing further access requests by an identified user or of a threatened resource.

In many cases, the pathway chosen by the analyst may be inconclusive. That is, the chosen pathway neither conclusively reveals the event to be a false positive or a potential threat. In such cases, the analyst may wish to explore other pathways to investigate the event. For example, the analyst may wish to return to certain nodes of the pathway and explore different pathways or branches, e.g., different case files, different pieces of evidence, or drill down on different data fields.

Today, it can be difficult and time-consuming for an analyst to explore alternate investigative pathways resulting in the so-called “rabbit hole” effect where the availability of rich data and abundant alternate investigation pathways can inhibit swift resolution of potentially time-sensitive events. In the example above, the analyst may soon have many windows open, each reflecting a snapshot of a moment in the investigative pathway. However, it can be difficult to understand how these windows are connected and how they relate to the investigative pathway. Consequently, these windows can be more like a box of loose snapshots and less like a photo album that tells a story. It is hard for the analyst to retrace steps, identify a node where a fruitless investigative branch was selected, and select a new branch for investigation. This may prevent a user from efficiently and timely concluding an investigation.

### SUMMARY OF THE INVENTION

The present invention is directed to a system and associated functionality for managing a workflow in a cybersecurity application to facilitate exploration of multiple investigative pathways and enable efficient and timely resolution of events. This is accomplished by creating a series of adjacent panels within a single user interface or window that reflect and memorialize an investigative workflow. The panels may be arranged to reflect multiple pathways of a single investigation. In this manner, an analyst can easily review the investigation, retrace steps, select an alternate pathway from any decision node of the investigation, and drill down into selected data elements of the investigation. The structure of the user interface thus records the investigative process so that it is well-documented, can be recalled by the analyst, can be understood by other analysts, and can be supplemented as needed.

In accordance with one aspect of the present invention, a system and method (“utility”) is provided for use in managing a workflow of a cybersecurity application. The utility involves operating the cybersecurity application to present, in a graphical workspace of a computer system, at least a portion of a user interface of the cybersecurity application, where the user interface comprises a root panel including multiple root data objects each having one or more root interactive elements. For example, the root panel may display a list of log messages resulting from a search of system alerts. Each log message in the display may include one or more hyperlinks to access detailed information concerning, for example, the log message, the reason for the alert, or data fields of the log message.

The utility further involves receiving a first user input associated with one of the root interactive elements. For example, an analyst may select a log message of interest and click on a link to obtain log inspection information. In response to this input, the utility may access a first data source to obtain first information associated with a corresponding root data object and present, in the user interface, a first branch panel including multiple branch data objects each having one or more branch interactive elements. In the case of the log inspection example, the first branch panel may include multiple panes having information concerning the nature of the alert and associated observations. This may include hyperlinks to access more detailed information concerning, for example, one or more of the observations that triggered the alert.

The utility may then receive a second user input associated with one of the root interactive elements or one of the branch interactive elements. That is, the analyst may select a hyperlink from one of the panes of the branch panel. Alternatively, the analyst may return to the root panel and select, for example, a different log message, to pursue a different investigative pathway. In either case, in response to the second user input, the system may access a second data source (the same as or different than the first data source) and present an additional panel including one or more additional panel interactive elements. The arrangement of the root panel, the branch panel, and the additional panel in the user interface is presented to portray a structure of one or more pathways of an investigation workflow concerning a cybersecurity event of interest. For example, if the additional panel is created in response to selection of a hyperlink in the branch panel, the additional panel may be presented adjacent to the branch panel and not necessarily adjacent to the root panel. Alternatively, if the additional panel is created in response to selection of a hyperlink in the root panel, the additional panel may be presented adjacent to the root panel and not necessarily adjacent to the branch panel. The structure of the user interface thereby reflects one or more investigative pathways of the investigation workflow.

### BRIEF DESCRIPTION OF THE DRAWINGS

For a more complete understanding of the present invention, and further advantages thereof, reference is now made to the following detailed description taken in conjunction with the drawings, in which:

FIG. 1 illustrates a user interface including a root panel and adjacent panels in accordance with the present invention;

FIGS. 2A-5F show a series of computer displays presenting a panel architecture in accordance with the present invention;

FIGS. 6-9 are schematic diagrams of user interface layouts reflecting different workflows in accordance with the present invention; and

FIG. 10 is a schematic diagram of a system for managing workflows in a cybersecurity application in accordance with the present invention.

### DETAILED DESCRIPTION

The following description shows certain workflows and examples of user interfaces that further illustrate the invention. It will be appreciated that many different workflows associated with different investigative processes are possible in accordance with the present invention. Moreover, the specific user interface used to implement the system of panels reflecting the structure of a workflow can be varied in accordance with the present invention. Accordingly, the following description should be understood as exemplary and not by way of limitation.

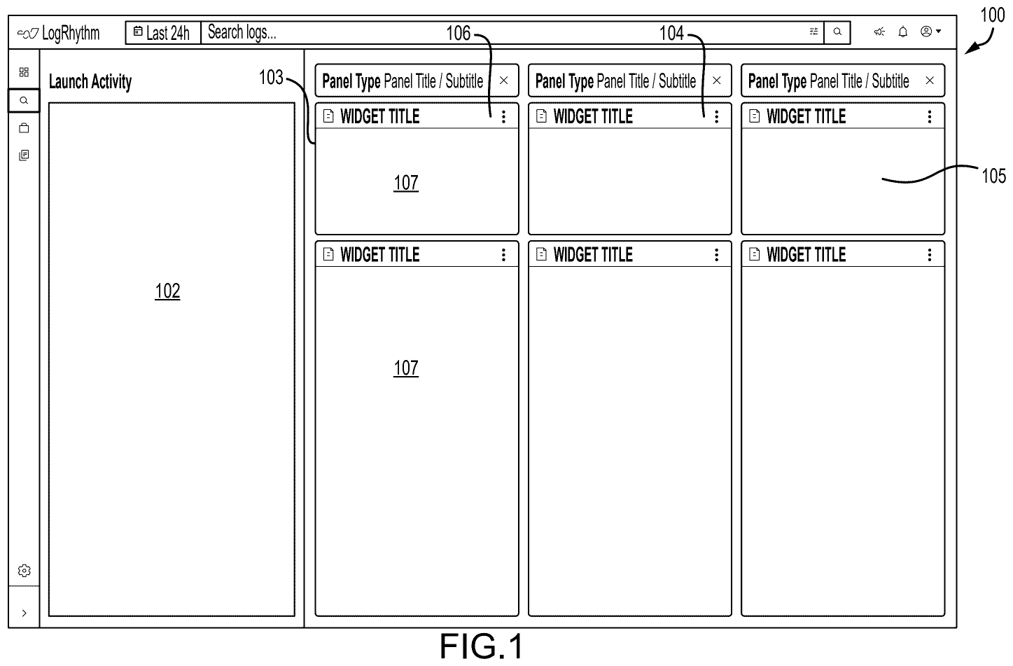

FIG. 1 illustrates a user interface 100 in accordance with the present invention. The illustrated user interface 100 generally includes a root panel 102 and a series of adjacent panels 103-105. The root panel 102 represents the starting point of a workflow. For example, the root panel 102 may present the results of a search query entered by an analyst. The search results may include a list of alerts or log messages. Alternatively, the root panel 102 may display a dashboard including alerts or other events updated in real time. In any event, the root panel 102 may provide a selection of interactive elements that can be used by an analyst to launch an investigation. For example, the interactive elements may include hyperlinks to access additional information about an alert or other event or to drill down into particular fields of data. Selection of one of these interactive elements causes the system to generate a panel 103 adjacent to the root panel 102. The additional panels 104 and 105, in the illustrated workflow, are generated in response to selecting interactive elements from the preceding panel.

In the illustrated workflow, each of the panels 103-105 includes a header 106 and a number of panes 107. Although not shown in FIG. 1, each of the panes 107 may include multiple data objects. These data objects are defined by an object type or data type, which represents what is displayed within the panel, e.g., security logs, account or host records, case investigations, alerts or notifications, etc. The data objects are further defined by a set of filter criteria, which define which specific records within the data set will be displayed. For example, the filter may return a set of multiple records to be summarized or only one record to be inspected.

The panel header 106 may identify the panel and may further enable access to certain panel-level functionality. For example, such functionality may include functionality for closing the panel, rearranging its order, renaming the panel, or modifying the panel's configuration settings. The panes 107 may be associated with panel widgets. These widgets define how the backing data for the panel is displayed to the user. Widgets may take the form of lists, grids, aggregate visualizations, or formatted metadata, among many other UI patterns. Similar to the panel header, each pane 107 may include a pane header to enable access to pane-level functionality. Within the panes 107, the data objects may include interactive elements that can be used to open new panels or enable key user workflows.

Once an initial branch panel is triggered by activating an interactive element of the root panel 102, it is displayed adjacent to (e.g., abutting or otherwise linked to) the root panel 102. An additional branch panel adjacent to the original branch panel may be generated by selecting an interactive element of the original branch panel, and so on. The number of panels in a workflow and corresponding user interface is, in principle, unbounded except by a system limit of computational power, memory, or performance. New panels may be appended to the workflow by direct user interaction or automated system configuration. To enable teams of cybersecurity analysts to communicate their findings on investigations, and entire workflow layout may be saved and shared via web link or an embedded system sharing function. Examples of such workflows are illustrated below.

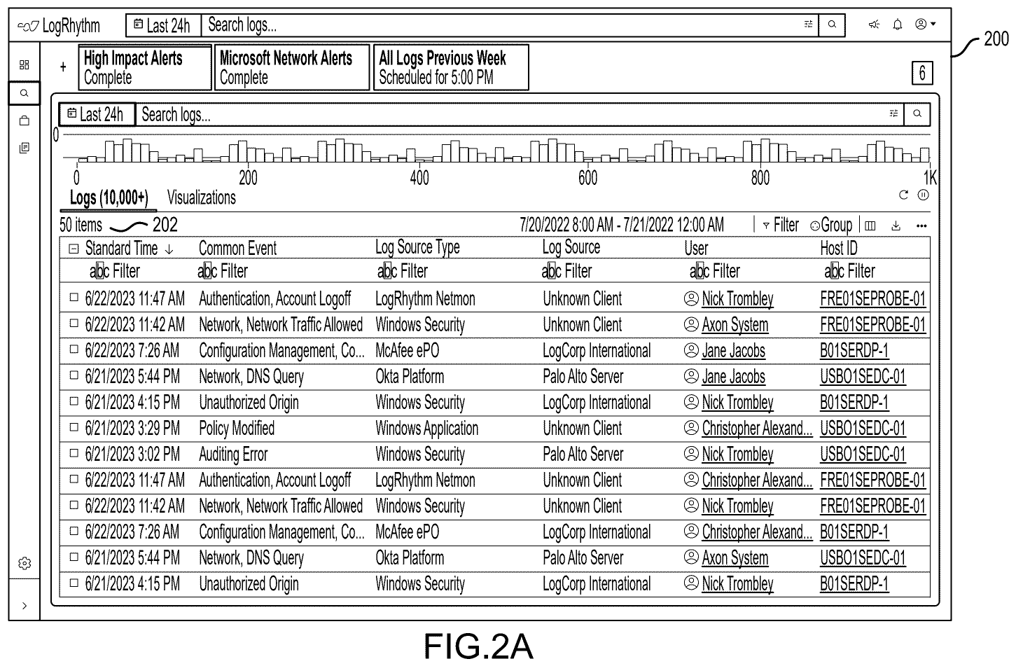

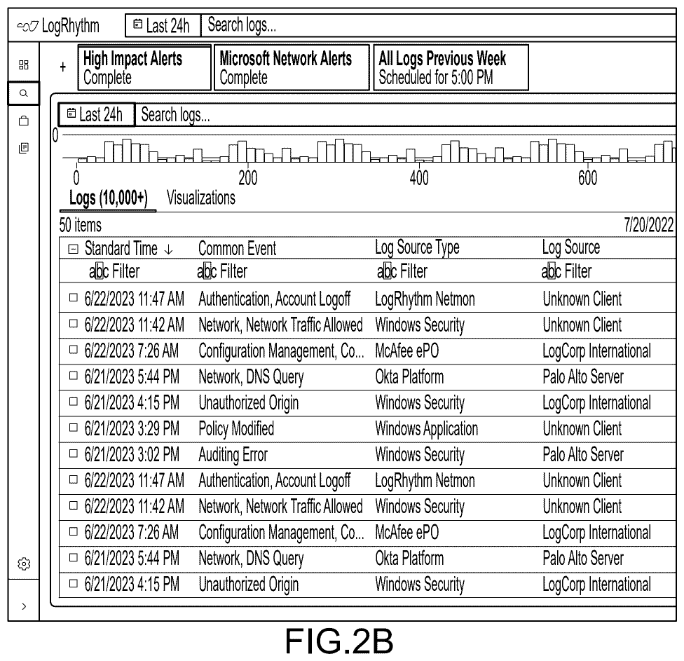

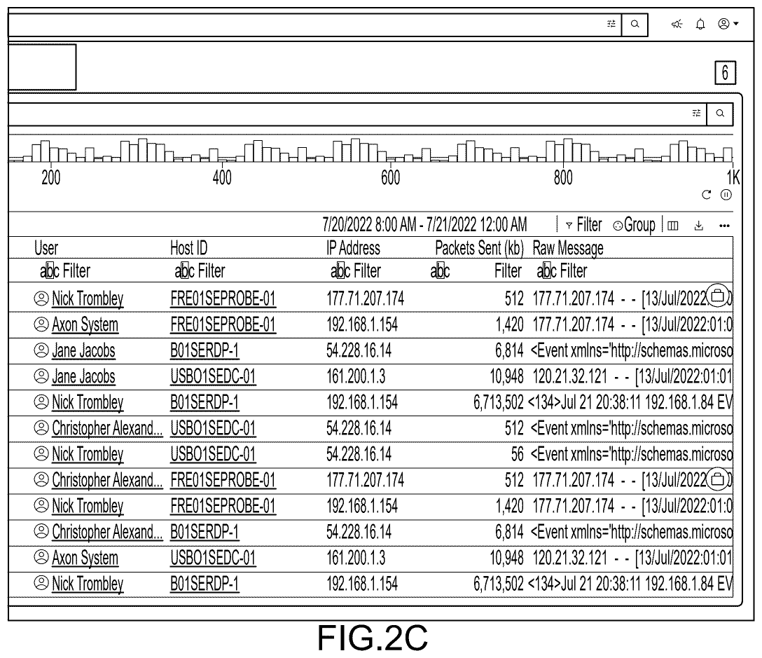

FIGS. 2A-6C show a series of computer displays presenting a panel architecture in accordance with the present invention. The panel architecture is structured in accordance with a workflow of a cybersecurity analyst. Referring first to FIGS. 2A-2C, a display 200 including a root panel 202 is shown. Specifically, FIG. 2A shows the full display 200 and FIGS. 2B-2C show enlarged views of portions of the display 200. The root panel 202 is the portion of a user interface or window from which an investigation is launched. This may be, for example, a dashboard interface of a cybersecurity application, a search results page, or any other user interface that an analyst may use to launch an investigation. In the illustrated example, the root panel 202 displays the results of a search implemented by an analyst employing filters to select “High Impact Alerts” that have occurred within the last 24 hours. It will be understood that analysts may use other screens, filters, search techniques, or the like to obtain items of information from which an investigation may be launched.

In the illustrated example, the root panel 202 includes rows of events or log messages. Within each row, there are multiple columns corresponding to different fields of information concerning the event or log message. An entire row may define an interactive element. In addition, some or all the resulting cells may include interactive elements such as hyperlinks. Conventionally, selection of such interactive elements would open a new window including additional information concerning the subject matter of the selected cell. For example, if an analyst selected a log message and then clicked on a user or host ID of that log message, the analyst would be presented with information regarding that user or that host ID in a new window.

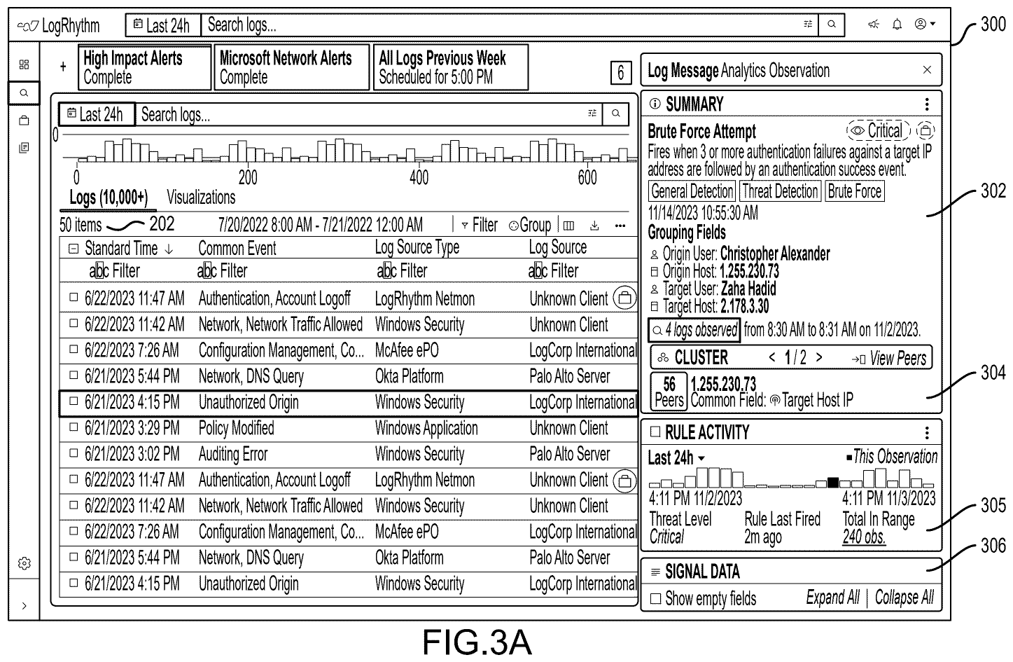

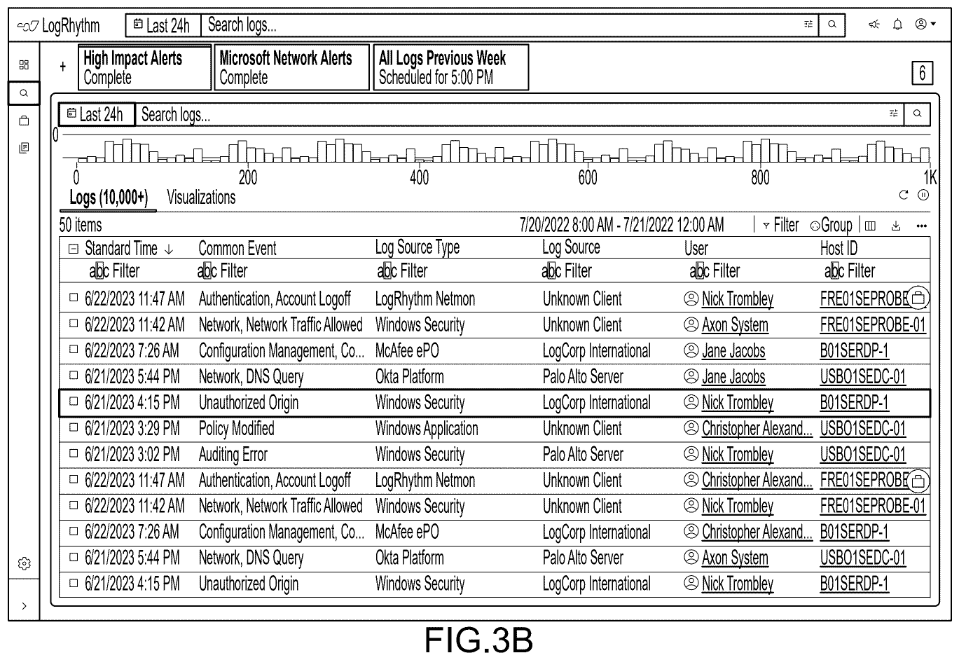

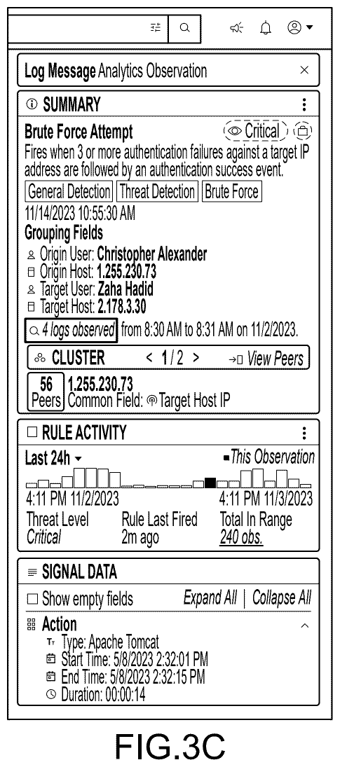

In accordance with the present invention, selection of such an interactive element does not open a new window but, rather, opens a new panel within the same user interface where the arrangement of the new panel is structured to reflect the workflow sequence. FIGS. 3A-3C show a display 300 presenting some or all of the user interface including the root panel 202 and a branch panel 302 generated in response to selecting an interactive element from the root panel 202. Specifically, in response to clicking on a selected row of the root panel 202, the system generates the branch panel 302 which, in the illustrated example, is a log inspector-type panel. The branch panel 302 is positioned adjacent to the root panel 202, in this case abutting the root panel 202 on its right side. In this case, the branch panel 302 includes a number of panes 304-306. Each of the panes includes multiple data objects and at least some of these data objects are associated with interactive elements. In the illustrated example, the branch panel 302 includes information concerning a Brute Force Attempt to access a target IP address.

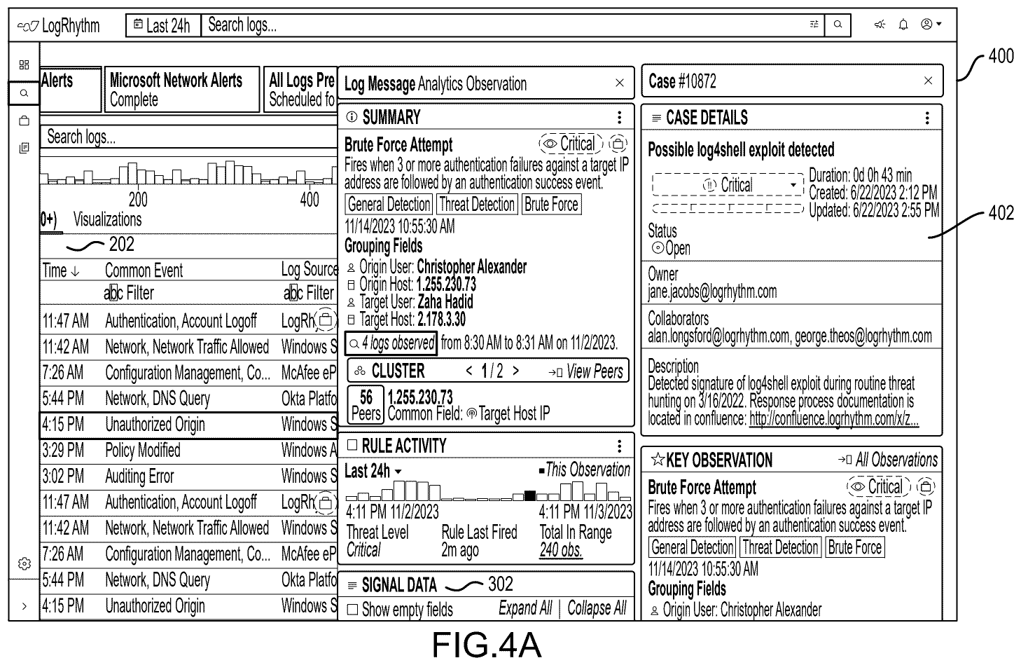

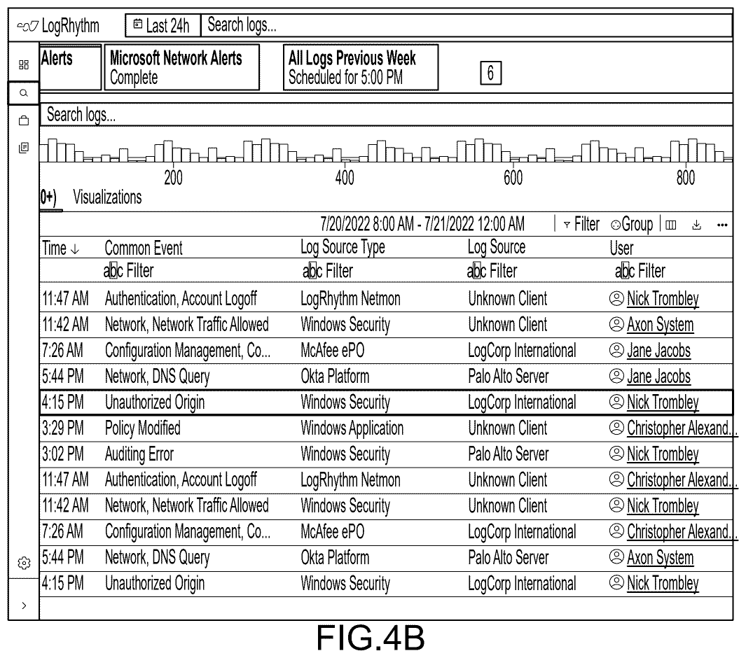

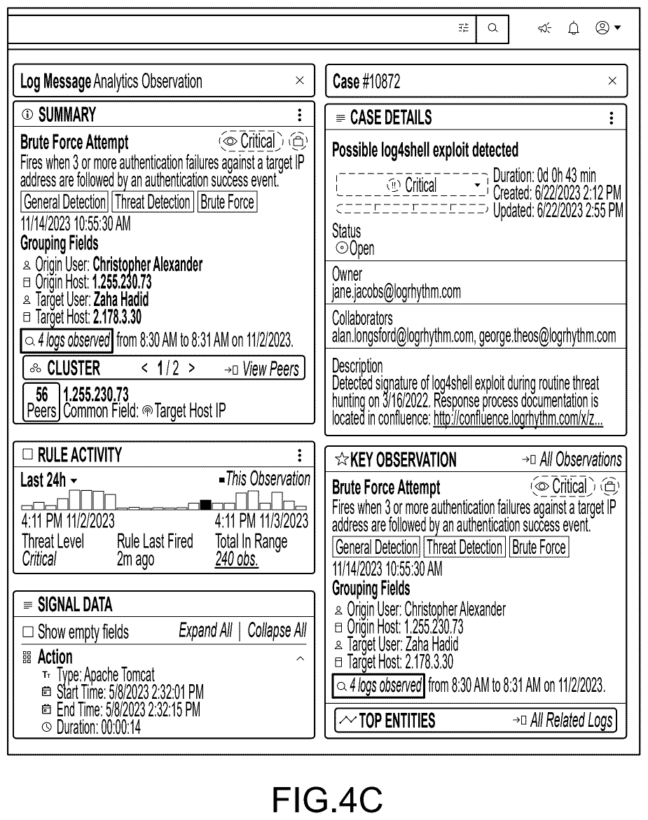

The analyst may desire to drill down further into an item of information presented in the branch panel 302. FIGS. 4A-4C show a display 400 including the root panel 202, the first branch panel 302, and a second branch panel 402. The first branch panel 302 indicates that the selected log message is associated with an open case. In the illustrated workflow, the second branch panel 402 is generated in response to clicking on the case button in the first branch panel 302. The resulting second branch panel 402 is a case inspector-type panel and opens to the right of the first branch panel 302 indicating that the second branch panel 402 is part of a flow path beginning with root panel 202, continuing to the first branch panel 302, and then to the second branch panel 402.

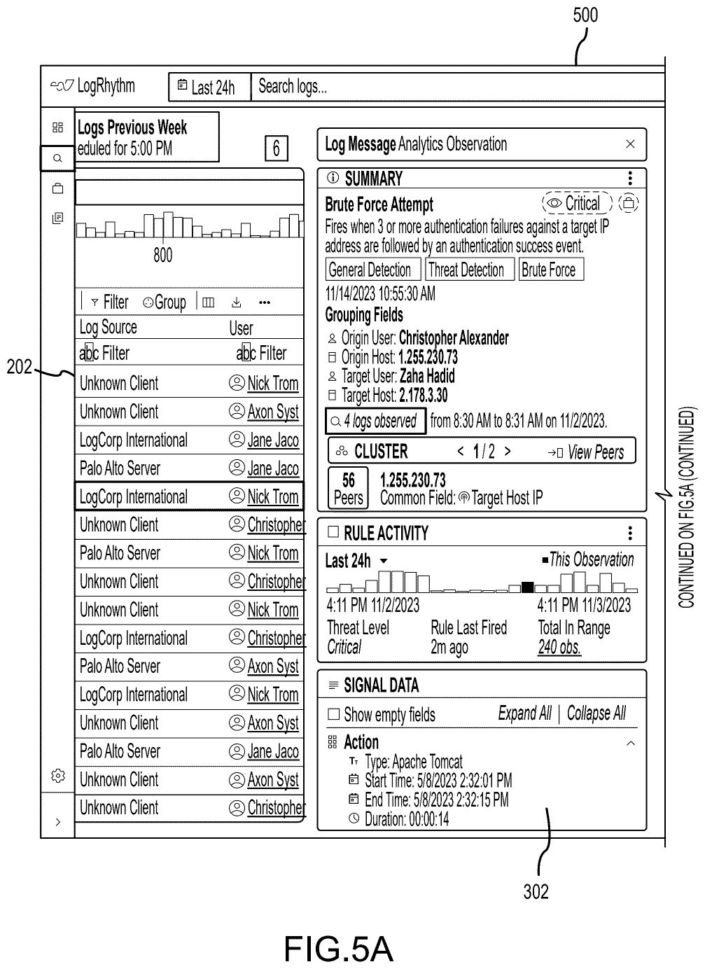

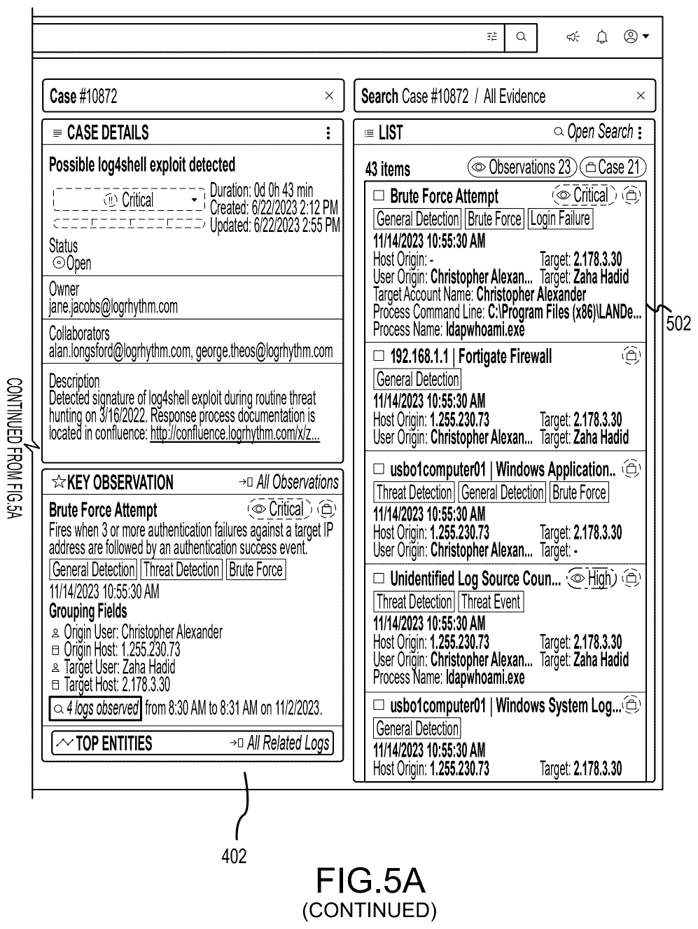

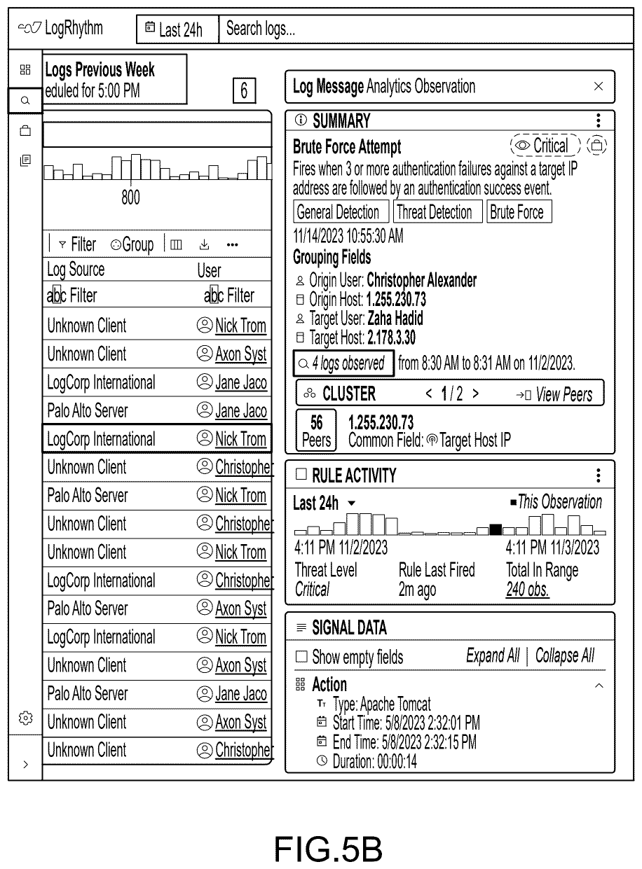

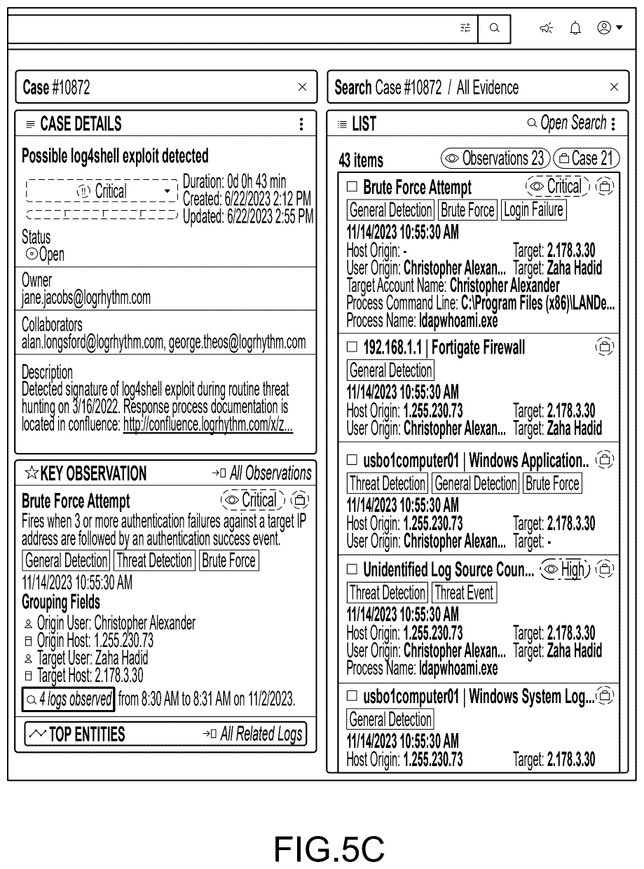

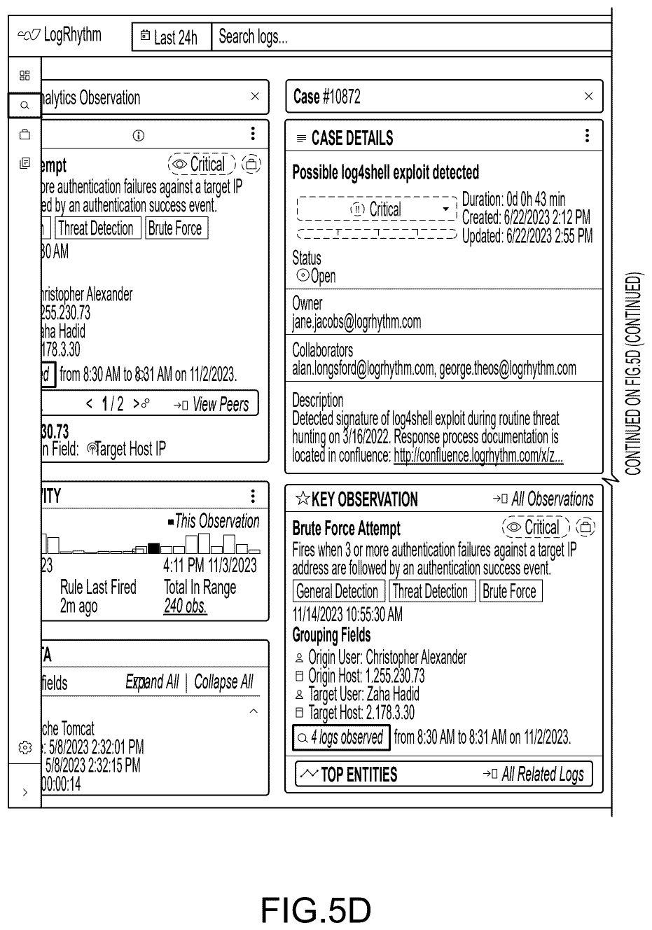

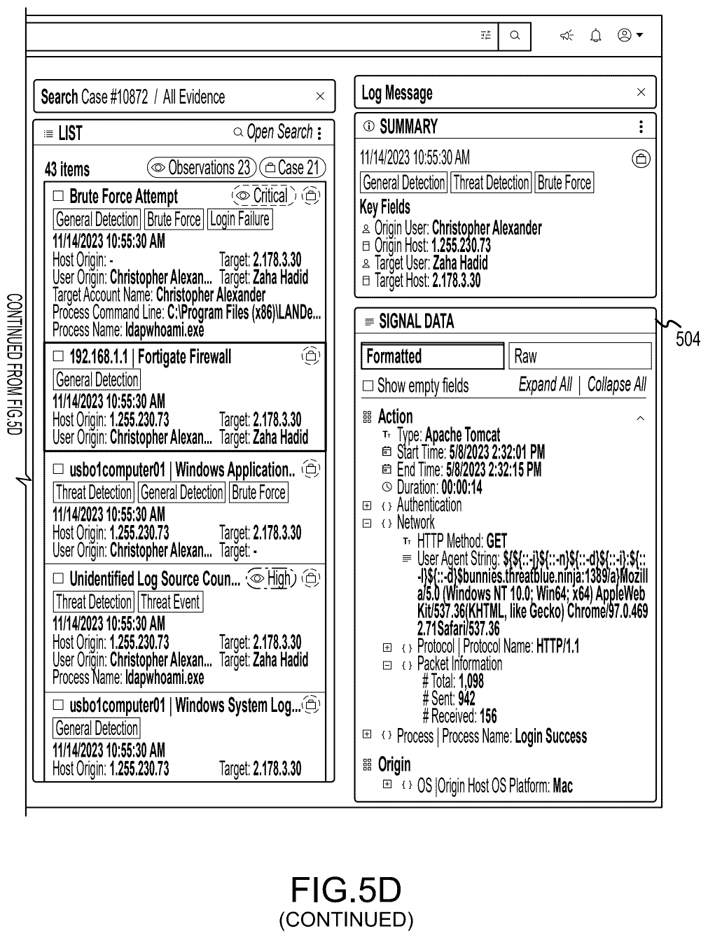

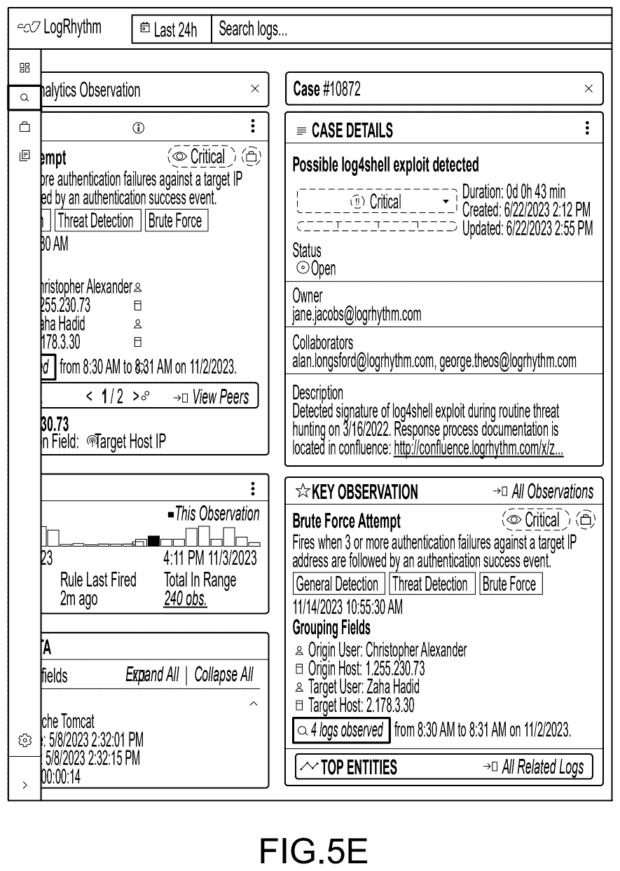

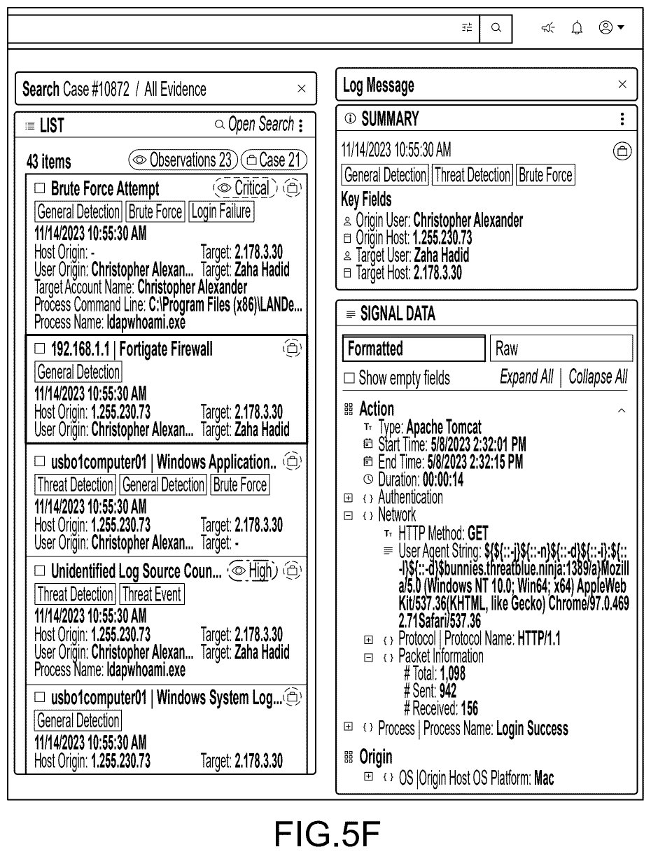

In the second branch panel 402, the analyst may note that the prior case included four logs that were observed and attached to the case file as evidence. The analyst may click on a link associated with the four logs observed to open a further panel. This is shown in FIGS. 5A-5C that include a display 500 including the root panel 202, the first branch panel 302, the second branch panel 402, and a third branch panel 502. By clicking on a single item in the resulting log list, a new log inspector-type panel 504 may be appended to the list as shown in FIGS. 5D-5F. It will be appreciated that additional panels may be appended to the user interface as the workflow continues. The analysts may back up through the workflow or close panels at any point if a particular investigative path no longer seems worth pursuing. The system may keep a record of the workflow paths for forensic purposes or to assist in further investigations. It will be appreciated that the panels are presented as part of a single user interface so that, for example, window-level navigation tools may be used to navigate between the various panels. For example, such navigation tools may include slide elements at the bottom or right-hand side of the display, mouse inputs executed after positioning a cursor within the window, or touchscreen inputs entered in relation to a display of the window.

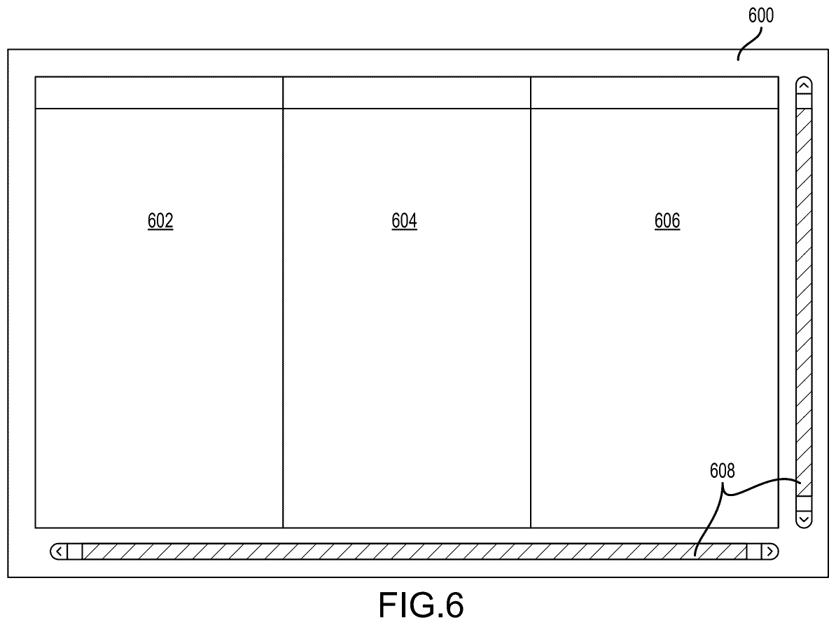

FIGS. 2A-5F illustrate a simple workflow associated with a single, linear flow path. However, it will be appreciated that many investigations are more complex involving backing up, pivoting, and multiple flow paths. The invention supports such complex workflows. FIGS. 6-9 illustrate some exemplary workflows. FIG. 6 shows a screen 600 presenting at least a portion of a workflow comprising a single, linear flow path including a root panel 602, a first branch panel 604, and a second branch panel 606. Such a workflow may be created by first selecting an item in the root panel 602 to generate the first branch panel 604, then selecting an item in the first branch panel 604 to generate the second branch panel 606. FIG. 6 also shows window-level navigation tools 608. The illustrated tools 608 are slide elements presented at the bottom and right-side edges of the display 600 that can be used to select what portions of the user interface are shown within the display 600.

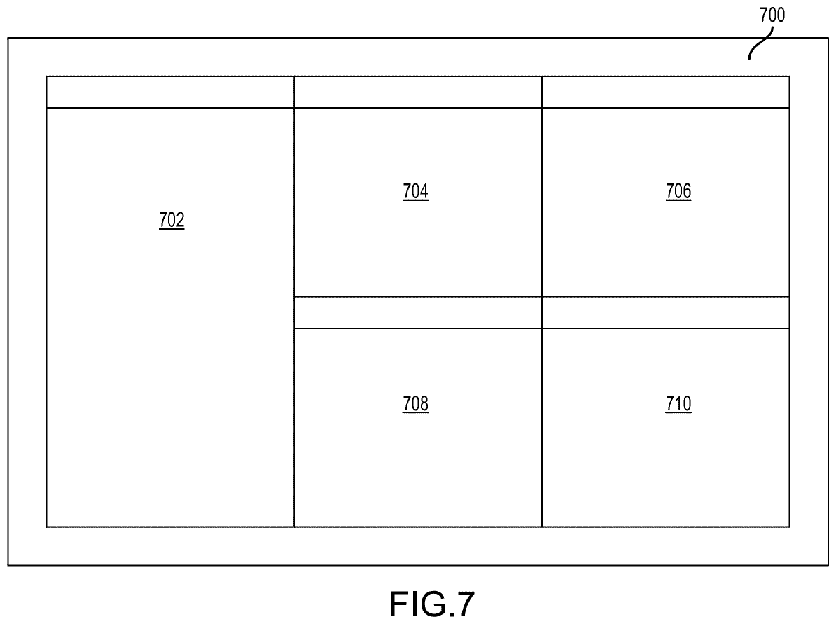

FIG. 7 shows a screen 700 depicting at least a portion of a more complicated workflow including multiple flow paths. A first flow path is defined by root panel 702, first branch panel A 704, and first branch panel B 706. A second flow path is defined by root panel 702, second branch panel A 708, and second branch panel B 710. For example, the first flow path may be created by selecting an item in the root panel 702 to generate first branch panel A 704, and then selecting an item in first branch panel A 704 to generate second branch panel B 706. At that point in the workflow, the analyst may back up to the root panel 702 to initiate the second flow path. Specifically, the analyst may item in root panel 702 to generate second branch panel A 708. The analyst may then select an item from second branch panel A 708 to generate the second branch panel B 710. In the illustrated implementation, the paths are geometrically portrayed as generally parallel paths. It will be appreciated that other arrangements are possible. For example, the second flow path could extend to the left of the root panel 702 or could be beneath or above the root panel 702. Alternatively, a three-dimensional representation could be employed.

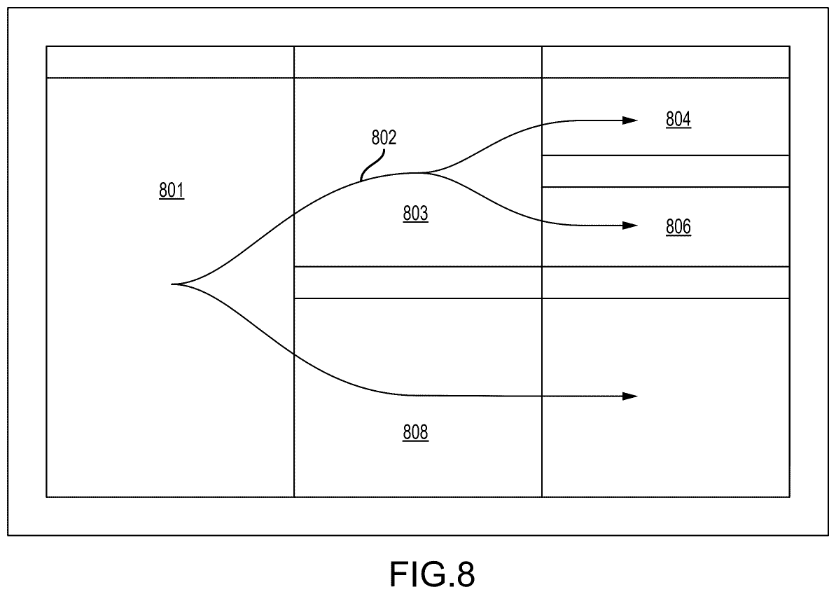

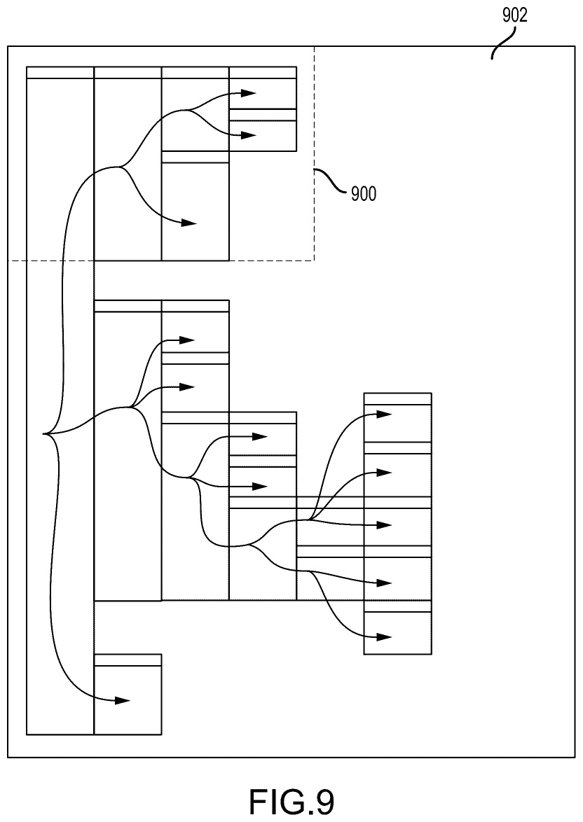

FIG. 8 shows a screen 800 depicting at least a portion of a still more complicated workflow. In this case, as in the previous example, to separate flow paths 802 and 808 emanate from the root panel 801. However, in this case, the first flow path 802 further branches into flow paths 804 and 806 at branch panel 803. FIG. 9 shows a screen 900 including a portion of a complex workflow including many branches and subbranches. It will be appreciated that a given flow path may branch at any level of the workflow and multiple branches may form at any such panel or decision node. Realistic investigations will often result in complex workflows. As shown in FIG. 9, the user interface 902 embodying the workflow may exceed the area presented in the display 900 at a given time.

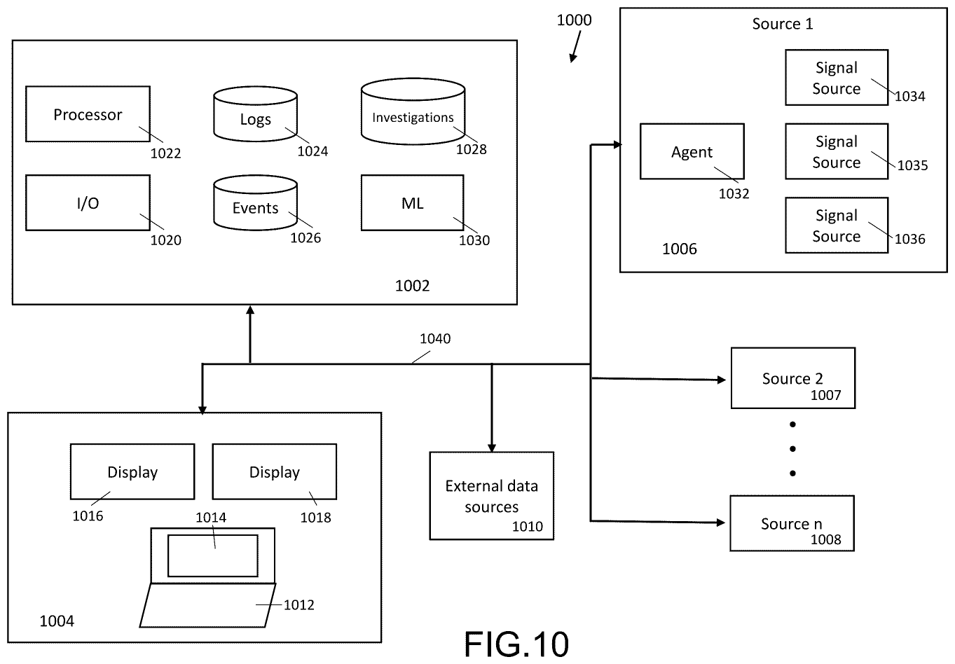

The panel flow path architecture as described above may be implemented by a network platform running a cybersecurity application. Such a platform may be executed in a local network environment or may be a cloud-based platform. FIG. 10 is a schematic diagram of an associated system 1000. The illustrated system 1000 includes a local or cloud-based network platform 1002, a user platform 1004 that may be used by an analyst to access the platform 1002, data sources 1006-1008 that are the source of log messages or other inputs used to identify and analyze events, and external data sources 1010 that may provide additional information for use in analyzing events.

The illustrated user platform 1004 includes a user device 1012 such as a laptop computer, a desktop computer, a tablet computer, or a phone. The user device 1012 may include an integral screen or monitor 1014 and may further include peripheral monitors 1016 and 1018. It will be appreciated that the user interface depicting the workflows as described above may be rendered on one or more of the screens/monitors 1014, 1016, and 1018.

The platform 1002 includes an input/output utility 1020 for managing communications between the platform and external elements 1004, 1006-1008, and 1010. For example, communications between these elements may be implemented via an API that defines message types, formats, protocols, data fields, and the like. The utility 1020 may implement the API by accessing information from the platform 1002 and transmitting outgoing messages, receiving incoming messages, parsing incoming messages, extracting data fields and values, and providing formatted data including metadata to the elements of the platform 1002.

The illustrated platform 1002 further includes a log database 1024, an events database 1026, and an investigations database 1028. The logs database 1024 stores information regarding logs generated by the data sources 1006-1008 or other devices or logic. It will be appreciated that many devices and applications generate log files in some or all of these log files may be used by a cybersecurity application to monitor a network. The events database 1026 may include information about activities that have been identified as events by the cybersecurity application. Such events may relate to potential threats to the network, anomalous activities, identified network conditions such as approaching storage thresholds, and the like. The investigations database 1028 may include information regarding investigations by analysts including ongoing and archived investigations. The database 1028 may store information concerning the structure of workflows as discussed above.

In addition to the databases 1024, 1026, and 1028, the illustrated platform 1002 may include a machine learning module 1030 and a processor 1022. The machine learning module 1030 may implement machine learning logic that is used to identify potential threats including emerging threats associated with new malware or the like. The module 1030 ingests a variety of input information and is operative to identify activities, patterns of activities, and other situations that may be used to identify and analyze events. The processor 1022 controls the operation of the elements of the platform 1002.

As described herein, the user device 1012 communicates with the platform 1002 to implement a variety of functions. Although the platform 1002 is illustrated as a single element, it will be appreciated that the platform 1002 may be executed on one or more machines (e.g., computers or servers) at a single site or geographically distributed. Each such site may execute the full functionality of the illustrated platform 1002 or the functionality may be distributed across sites. Moreover, the functionality may be distributed in various ways between the platform 1002, the user device 1012, and other platforms 1006-1008 and 1010, e.g., some preprocessing of log information or search requests may be executed at the user device 1012 or sources 1006-1008, for example, to facilitate rapid response or reduce use of processing resources of the platform 1002 or communication bandwidth requirements. The platform 1002 may be hosted by a network operator or may be implemented separately (e.g., cloud-based) and connected to a monitored network via an interface such as API 1040.

The data sources 1006-1008 are the sources of log messages or other information that is used to monitor a network environment. One or more of the sources 1006-1008 may include multiple signal sources 1034-1036 that are the devices or logic that generate log messages or other data signals. Multiple signal sources 1034-1036 may be associated with a log agent 1032 that obtains the log messages or other data signals (or abstracted data thereof) and, optionally, preprocess the signals. The system 1000 may further employee other external data sources 1010. For example, the system may ingest literature or alerts from software providers or other third parties concerning potential threats or other information that is useful in identifying and analyzing potential threats.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. A method for use in managing a workflow of a cybersecurity application, comprising:
operating said cybersecurity application to present, in a graphical workspace of one or more monitors, at least a portion of a user interface of said cybersecurity application, said user interface comprising a root panel including multiple root data objects, each having one or more root interactive elements;
receiving, in connection with said user interface, a first user input associated with a first element of said root interactive elements;
in response to said first user input, accessing a first data source to obtain first information associated with a corresponding one of said root data objects and present, in said user interface, a first branch panel including multiple branch data objects, each having one or more branch interactive elements;
receiving, in connection with said user interface, a second user input associated with one of said root interactive elements or one of said branch interactive elements; and
in response to said second user input, accessing a second data source, the same as or different than said first data source, and presenting, in said user interface, an additional panel including one or more additional panel interactive elements;
wherein an arrangement of said root panel, said branch panel, and said additional panel in said user interface is presented to portray a structure of one or more workflows of an investigation concerning a cybersecurity event of interest.

2. The method of claim 1, wherein said user interface comprises a window supporting one or more window-level actions including one of closing the window, minimizing the window, renaming the window, and modifying the windows configuration settings.

3. The method of claim 1, wherein said user interface has a display size that exceeds a display area of one of said monitors.

4. The method of claim 2, wherein each of said root panel, said branch panel, and said additional panel is subject to said window-level actions.

5. The method of claim 1, wherein each of said root panel, said branch panel, and said additional panel supports one or more panel-level actions comprising one of closing the panel, rearranging an order of said panel, renaming said panel, or modifying configuration settings of said panel.

6. The method of claim 1, wherein said first element comprises a hyperlink associated with a first data object of said root panel and said first user input comprises activating said hyperlink.

7. The method of claim 6, wherein, in response to activating said hyperlink, said branch panel is generated in said user interface adjacent said root panel.

8. The method of claim 1, wherein said additional panel is presented in response to selecting one of said branch interactive elements of said branch panel.

9. The method of claim 8, wherein said additional panel is generated in said user interface adjacent said branch panel.

10. The method of claim 1, wherein said additional panel is presented in response to selecting one of said root interactive elements of said root panel.

11. The method of claim 10, wherein said additional panel is generated in said user interface adjacent said root panel.

12. The method of claim 1, wherein said user interface includes a series of adjacent panels reflecting a sequence of investigative actions of an investigative pathway.

13. The method of claim 1, wherein said user interface includes a first series of adjacent panels and a second series of adjacent panels reflecting first and second respective investigative pathways.

14. The method of claim 1, further comprising storing a structure of said user interface that reflects one or more investigative pathways.

15. The method of claim 1, wherein a user can navigate across said root panel, said branch panel, and said additional panel, using window-level navigation tools.

16. The method of claim 15, wherein said user can operate said window-level navigation tools using one of a keyboard, a mouse, and a touchscreen.

17. A system for use in managing a workflow of a cybersecurity application, comprising:
a computer platform running a cybersecurity application operative for:
presenting, in a graphical workspace of one or more monitors, at least a portion of a user interface, said user interface comprising a root panel including multiple root data objects, each having one or more root interactive elements;
receiving, in connection with said user interface, a first user input associated with a first element of said root interactive elements;
in response to said first user input, accessing a first data source to obtain first information associated with a corresponding one of said root data objects and present, in said user interface, a first branch panel including multiple branch data objects, each having one or more branch interactive elements;
receiving, in connection with said user interface, a second user input associated with one of said root interactive elements or one of said branch interactive elements; and
in response to said second user input, accessing a second data source, the same as or different than said first data source, and presenting, in said user interface, an additional panel including one or more additional panel interactive elements;
wherein an arrangement of said root panel, said branch panel, and said additional panel in said user interface is presented to portray a structure of one or more workflows of an investigation concerning a cybersecurity event of interest.

18. The system of claim 17, wherein said user interface comprises a window supporting one or more window-level actions including one of closing the window, minimizing the window, renaming the window, and modifying the windows configuration settings.

19. The system of claim 17, wherein said user interface has a display size that exceeds a display area of one of said monitors.

20. The system of claim 18, wherein each of said root panel, said branch panel, and said additional panel is subject to said window-level actions.

21. The method of claim 17, wherein each of said root panel, said branch panel, and said additional panel supports one or more panel-level actions comprising one of closing the panel, rearranging an order of said panel, renaming said panel, or modifying configuration settings of said panel.

22. The system of claim 17, wherein said first element comprises a hyperlink associated with a first data object of said root panel and said first user input comprises activating said hyperlink.

23. The system of claim 22, wherein, in response to activating said hyperlink, said branch panel is generated in said user interface adjacent said root panel.

24. The system of claim 17, wherein said additional panel is presented in response to selecting one of said branch interactive elements of said branch panel.

25. The system of claim 24, wherein said additional panel is generated in said user interface adjacent said branch panel.

26. The system of claim 17, wherein said additional panel is presented in response to selecting one of said root interactive elements of said root panel.

27. The system of claim 26, wherein said additional panel is generated in said user interface adjacent said root panel.

28. The system of claim 17, wherein said user interface includes a series of adjacent panels reflecting a sequence of investigative actions of an investigative pathway.

29. The system of claim 17, wherein said user interface includes a first series of adjacent panels and a second series of adjacent panels reflecting first and second respective investigative pathways.

30. The system of claim 17, further comprising storing a structure of said user interface that reflects one or more investigative pathways.

31. The system of claim 17, wherein a user can navigate across said root panel, said branch panel, and said additional panel, using window-level navigation tools.

32. The system of claim 31, wherein said user can operate said window-level navigation tools using one of a keyboard, a mouse, and a touchscreen.
